(19) United States
(12) Patent Application Publication
(10) Pub. No.: US 2006/0221198 A1
(43) Pub. Date: Oct. 5, 2006

(54) User established variable image sizes for a digital image capture device

(76) Inventors: Jared Fry, Boston, MA (US); Eric Anderson, Gardnerville, NV (US)

Correspondence Address: SCENERA RESEARCH, LLC, 111 Corning Road, Suite 220, Cary, NC, 27511, US

(21) Appl. No.: 11/096,807

(22) Filed: Mar. 31, 2005

(51) Int. Cl. H04N 5/228

(52) U.S. Cl. 348/222.1

(57) ABSTRACT

Methods and apparatus for allowing a user to establish variable image sizes in a digital image capture device having an image sensor are described. Aspects of the present invention include allowing the user to specify a custom output size for an image about to be captured using the image capture device by specifying a value for one of an image dimension, an aspect ratio of the image, and a print size of the image; determining from the user-specified output size for the image a corresponding capture area of the image sensor; capturing sensor data corresponding only to the capture area of the image sensor; and processing the captured sensor data into the image of the user-specified output size.

### FIELD OF THE INVENTION

The present invention relates to a digital image capture device, and more particularly to a method and apparatus for allowing a user to establish variable image sizes for a digital image capture device.

### BACKGROUND OF THE INVENTION

Digital image capture devices such as digital cameras and camera phones typically capture images using standard aspect ratios, i.e., the ratio between the height and width of an image. The two aspect ratios that are most common are 4:3 and 3:2. These ratios are common due to the fact that most computer screens and video monitors have a 4:3 ratio, and traditional 35 mm film photography creates negatives that have a 3:2 (and thus 4″×6″ is a common print format).

Because digital cameras have resolution that is quite high, and sometimes far beyond what is needed, some digital cameras will give a user the option to choose the resolution at which they want the images to be captured. For example, a user of a SONY DSC-F707 can choose from the following resolutions:

2560×1920

2560 (3:2) [2560×1707]

2048×1536

1280×960

640×480

Note that all of the resolution options have an aspect ratio of 4:3, except for the second one (“2560 (3:2)”), has a 3:2 aspect ratio. In this camera, users have the option to capture the highest resolution photographs possible with either a 4:3 or a 3:2 aspect ratio.

Theater screens, televisions, and computer displays (desktop and laptop) have introduced a new aspect ratio standard: 16:9. Additionally, there are instances when images need to be submitted for publication that are of a particular size and aspect ratio. To create images of aspect ratios that are not either 4:3 or 3:2, one must edit an image on a computer using image editing software, which a very manual process.

One example of this process is disclosed in U.S. Pat. No. 6,650,366 (hereinafter the '366 patent). In the '366 patent, a digital camera stores uncompressed digital images captured from an image sensor on a memory within the camera. The user then selects the images to be processed, and also specifies the desired cropping size of an output image. The size can either be specified in pixels or in the final print size. An image processing program then crops the image as specified by the user and performs the CFA interpolation and spatial processing to produce the final output image. The cropping and interpolations steps may either be performed on a host computer or within the digital camera. The purpose of this patent is to conduct a cropping function in the camera on the image prior to interpolating it a single time, rather than having it interpolated first in the camera, then cropped on a PC and ‘upsized’ to a higher resolution (of the cropped aspect ratio) thus requiring a second interpolation. This second interpolation, because it is creating pixels, will create undesired image artifacts. An example of the reason the image would be ‘upsized’ would be if the user captured an image at a resolution of 1280×960 (4:3) but wanted to print the image on a 7″×10″ format paper at 300 dpi, thus requiring an image of 3072×2048 (3:2) resolution.

U.S. patent publication No. 2004/0257458 also refers to adjustable aspect-ratios, but only in terms of a view-finding method for a digital camera, rather than adjustable aspect ratios for actual captured images. In this publication, a user of the digital camera selects an aspect ratio from a set of be determined aspect ratios. Then, an image frame to be taken by the image capture apparatus is shown in the viewfinder of the digital camera and marked according to the selected aspect ratio to distinguish a desired frame portion from the other frame portion. Information associated with the selected aspect ratio is then recorded into the digital file of the captured image. When the captured digital image is to be developed or printed, an image-outputting apparatus outputs an image frame conforming to the selected aspect ratio.

Although the above described conventional approaches for providing a user with a method for adjusting aspect ratios, these conventional approaches have several disadvantages. One disadvantage is that users are limited to at most two different aspect ratios, 4:3 and 3:2, and thus can not easily create images of the 16:9 aspect ratio or any non-standard aspect ratio. A related disadvantage is that users are limited to a finite number of manufacturer preset image sizes (as listed above for the Sony DSC-F707), and thus are unable to easily and automatically create images of non-standard sizes, even if at a standard aspect ratio. A further disadvantage is that in both conventional methods described above, the image sensor captures a full-sized image, with is then subsequently cropped and interpolated. The result is that unnecessary data is collected from the image sensor, causing unnecessary conversion processing and thus waste of battery life in the digital camera, waste of processing time, as well as using more of the camera storage memory than necessary.

Accordingly, what is needed is a method and apparatus for allowing a user to establish variable image sizes in a digital image capture device. The method and apparatus should allow users of digital image capture devices to define an image size, capture an image, and have the resulting image be of the user defined size.

### BRIEF SUMMARY OF THE INVENTION

The present invention provides a method and apparatus for allowing a user to establish variable image sizes in a digital image capture device having an image sensor. Aspects of the present invention include allowing the user to specify a custom output size for an image about to be captured using the image capture device by specifying a value for one of an image dimension, an aspect ratio of the image, and a print size of the image; determining from the user-specified output size for the image a corresponding capture area of the image sensor; capturing sensor data corresponding only to the capture area of the image sensor; and processing the captured sensor data into the image of the user-specified output size.

A second embodiment of the present invention provides the ability to scale the image data directly from the raw sensor data, rather than interpolate data from an image file. The image data may be upscaled in case where the user has specified a custom pixel size larger than the image sensor, or the image data may be downscaled in the case where the user specifies a size smaller than the image sensor. In the case where the custom size is larger than the image sensor, the image capture device calculates the aspect ratio from the custom size, and captures the image by only digitizing pixel values for the largest area of the image sensor possible that maintains the calculated aspect ratio, rather than process the entire pixel array. The raw data will be available to the interpolation/scaling algorithm to make maximum use of the sensor data to create the output image. Because the raw sensor data is available, and the scaling function can be combined with the interpolation function, a better high resolution image will result than simply scaling an already interpolated and compressed image.

Downscaling provides the image capture device with the ability to output user-specified image sizes that are smaller than the sensor array. This embodiment of the present invention provides an improved approach to producing images smaller than the sensor size by taking the largest amount of sensor data available for the specified aspect ratio, and then interpolating and scaling the image data to the desired size. The combined interpolation and scaling function, including a carefully-designed sharpening algorithm will result in an image of higher quality because more than one sensor pixel data is used for each output pixel. The file created is of the specified size, but the quality is higher as the size is reduced. This of course will not reduce the processing load and battery drain, but will reduce storage requirements and give superior results.

According to the method and apparatus disclosed herein, the present invention allows the user to create an image of the desired size and shape attributes automatically in the image capture device, rather than needing to edit the image using image editing software on a personal computer. In addition, the image device only captures data corresponding to an image of the specified custom size. Finally, the user is able to view exactly the image to be captured on the camera viewfinder prior to capture.

### BRIEF DESCRIPTION OF THE DRAWINGS

FIG. 1 is a flow diagram illustrating the process for allowing the user to establish variable image sizes in an image capture device in accordance with a preferred embodiment where the user enters a pixel dimension for the images

FIG. 2 is a block diagram illustrating a digital image capture device architecture for use in accordance with the present invention.

FIG. 3 is a flow diagram illustrating the process for allowing the user to establish a variable image sizes in further detail.

FIGS. 4A, 4B, and 4C are diagrams illustrating an exemplary user interface for digital image capture device for implementing a preferred embodiment of the present invention.

FIGS. 5A and 5B depict a diagram illustrating a detailed process for establishing variable image sizes in accordance with a second embodiment in which scaling is performed.

### DETAILED DESCRIPTION OF THE INVENTION

The present invention relates to a method and apparatus for allowing a user to establish variable image sizes for a digital image capture device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and apparatus for allowing a user to establish variable image sizes in a digital image capture device, such that the resulting image is of a user defined size, including aspect ratio and/or the number of pixels. The preferred embodiment allows the user of the image capture device to specify a custom output size for images about to be captured. The user may specify the custom size by entering a value for the image dimension (e.g., in pixels), an aspect ratio, or a print size. In response, the image capture devices determines from the user-specified output size for the image a corresponding capture area of the image sensor, and sensor data is then captured by the image sensor corresponding only to the capture area of the image sensor. The image capture device then processes the captured sensor data into the image of the user-specified output size. By using only the part of the image sensor necessary for capturing the image of the specified custom size, the present invention eliminates the need for unnecessary conversion processing and therefore extends the battery life of the digital image capture device. In addition, the image captured device will use less memory and have a faster image processing time in most cases.

The present invention includes two embodiments, one that does not perform scaling on the captured sensor data and one that performs scaling. The non-scaling embodiment is described first, followed by the scaling embodiment.

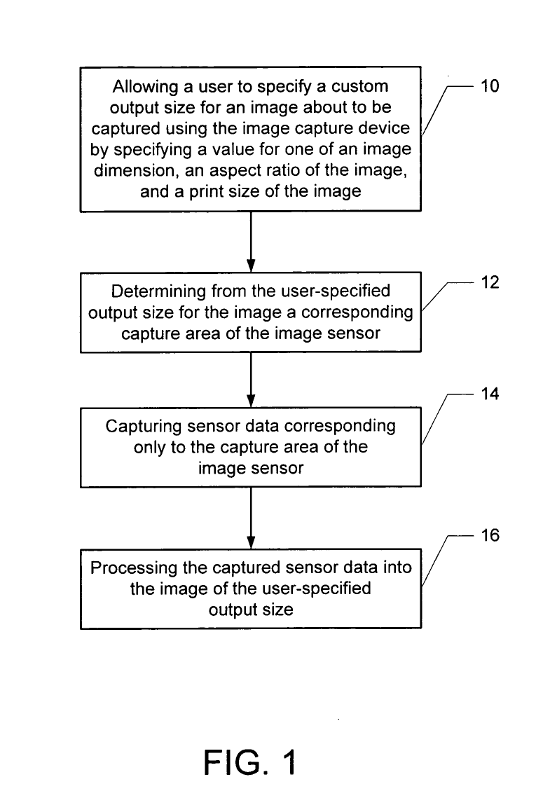

FIG. 1 is a flow diagram illustrating the process for allowing the user to establish variable image sizes in an image capture device in accordance with a preferred embodiment in which the user enters a pixel dimension for the images. The process begins in step 10 in which a user is allowed to specify a custom output size for an image about to be captured using the image capture device by specifying a value for one of an image dimension, an aspect ratio of the image, and a print size of the image. For example, a screen can be displayed on the user interface of the image capture device that allows user to enter custom height and width (H×W) pixel-dimensions for the desired output file, which also inherently sets the aspect ratio. When entering pixel dimensions, setting the pixel width may be independent of setting the pixel height, and thus any possible range between 1 and the image sensor's physical limits for either dimension is feasible. For this “non-scaling” embodiment, an alternate method of specifying the desired output file size includes setting the aspect ratio of image to be captured. In this case, the maximum sensor area is computed in pixels that conforms to the specified aspect ratio.

In step 12, a corresponding capture area of the image sensor is determined based on the user-specified output size for the image. In addition, the image capture device can determine if the specified custom size is valid. This may be accomplished by comparing a custom size with the maximum pixel dimensions of the image sensor, and then alerting the user of an invalid entry if the user attempted to exceed any of the device's maximum pixel dimensions.

In step 14, sensor data is captured corresponding only to the capture area of the image sensor. For example, in response to the user pressing the shutter button or otherwise initiating an image capture, the camera capture electronics are instructed to only capture and process the pixels in the image sensor falling within dimensions of the capture area calculated from the user input. In an image sensor such as a charge coupled device (CCD), for example, all of the unnecessary pixel rows outside of the capture area would be shifted down and discarded prior to conversion of the pixels comprising the image. In a CMOS image sensor, only the pixels defined by the capture area are actually acquired. With a complementary metal oxide semiconductor (CMOS) sensor, a processor in the image capture device can read the image data for each pixel individually without having to “shift-out” the undesired pixel data first like one would need to do with a CCD sensor.

In step 16, the captured sensor data is processed into the image of the user-specified output size. The pixel data captured by the image sensor has the pixel height and width specified by the custom size entered by the user. The processed sensor data can then be saved in an image file, which can viewed, transmitted, or printed as desired.

According to an exemplary embodiment, the image capture device can display a live view image of a scene about to be captured by the image sensor using only an area of the image sensor that matches the dimension/aspect ratio of the custom size defined by the user. The live view image can be presented in a viewfinder or display portion of the image capture device. This can give the user the ability to accurately frame and view their images prior to being captured. In a related embodiment, if the live view image falls beneath a predetermined threshold size, then the live view image can be scaled up to provide the user with a larger view of the scene.

Accordingly, the preferred embodiment of the present invention has several advantages. One advantage is that it gives the user complete freedom to capture images of any pixel size they desire and at any aspect ratio they want (within the quality limitations of image sensor). Another advantage is that it allows the user to frame an image at a non-standard size and/or aspect ratio in the camera viewfinder prior to the image being captured, rather than the user manually cropping the image after the fact using a software application. A further advantage is that, depending on the chosen output image size, unnecessary data conversion and processing can be avoided, which can improve the reserve battery power of the image capture device.

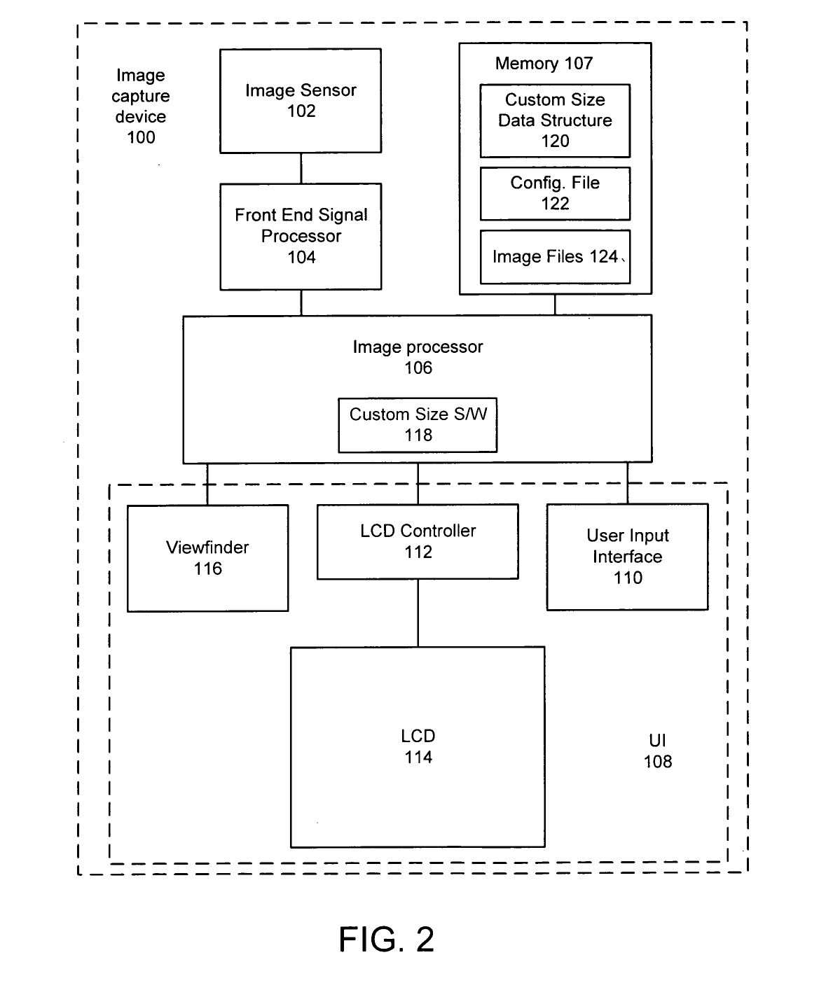

FIG. 2 is a block diagram illustrating a digital image capture device architecture for use in accordance with the present invention. The architecture described below may apply to any portable electronic device equipped with a digital camera, including a digital still camera, a digital video camera, a PDA, or camera phone, for example. The digital image capture device 100 preferably comprises an image sensor 102, a digital camera front-end signal processor 104, a processor 106, at least one memory 107 and a user interface 108. The user interface 108 further comprises user input interface 110, an LCD controller 112, a display 114, and an optional viewfinder 116. The image sensor 102 may comprise a CCD, CMOS or other type of sensor, and the elements therein may comprise pixels or photosites. The user interface 108 allows a user to control features, functions, and settings of image capture device 100, including specifying custom image sizes, while the processor 106 controls and implements the features and functions of the image capture device 100.

In a preferred embodiment, the custom image size feature is implemented in software 118 that is executed by processor 106 and displays a screen on the display 114 to allow the user to set a custom image size prior to image capture using the user input interface 110. Once the user enters a value(s) for the custom image size, the customary size value is stored in a custom size data structure 120 in the memory 107. The maximum dimensions 122 of the image sensor 102 may be included in a configuration file 122 that also may be stored in the memory 107.

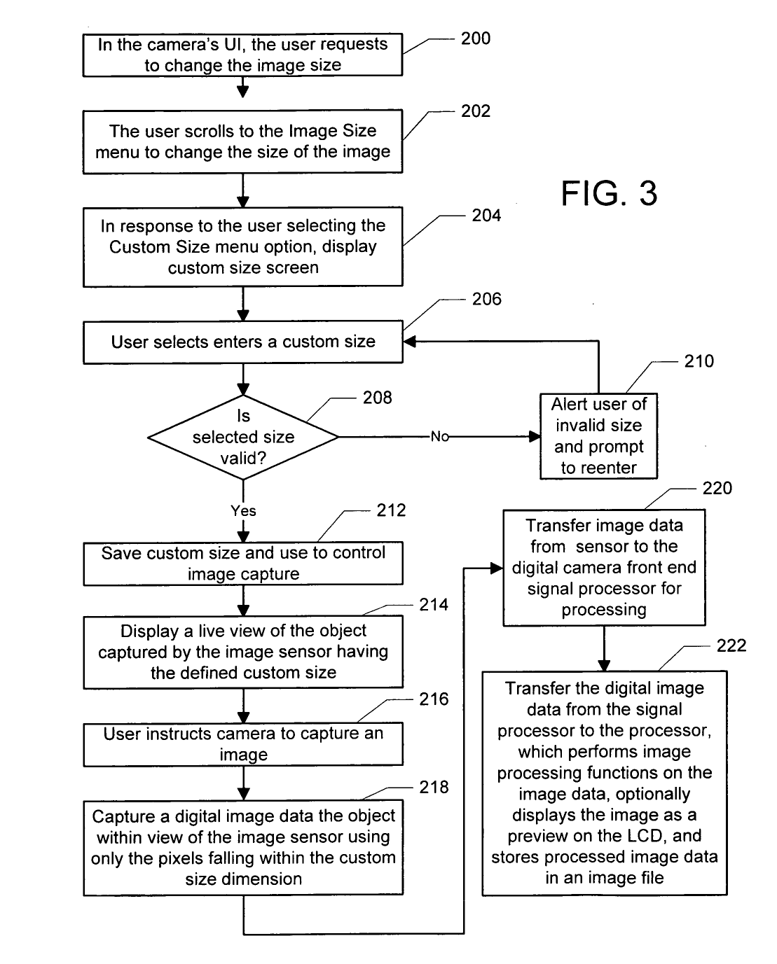

FIG. 3 is a flow diagram illustrating a process for allowing the user to establish a variable image sizes in further detail.

Referring to FIG. 3, the process begins in step 200 in which a user of the image capture device, prior to capturing a set of one or more images, requests to change the image size. In a preferred embodiment, this is done by pressing a menu button in order to access a menu for adjusting camera's settings and parameters. In preferred embodiment, a list of camera settings options is displayed including an “Image Size” menu. In step 202, the user scrolls to the Image Size menu to change the image size.

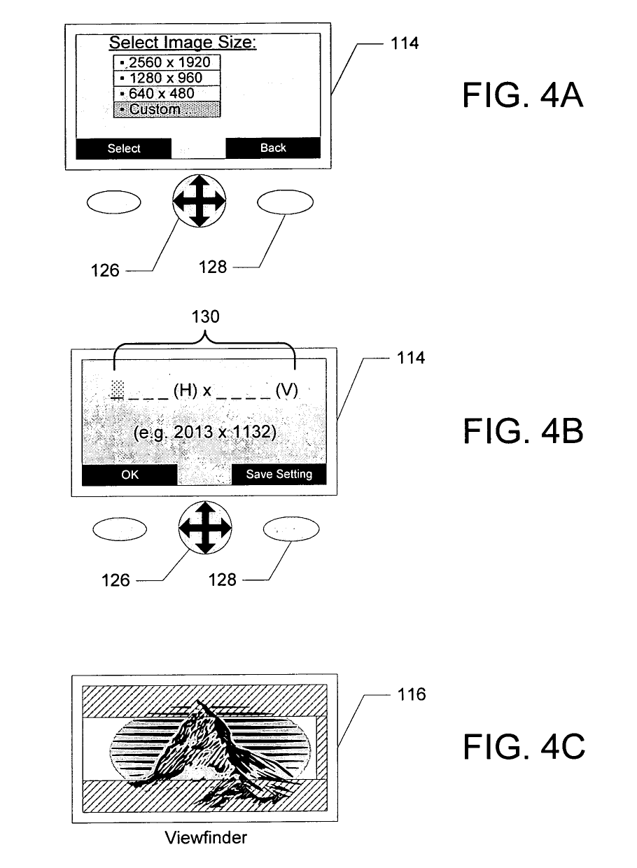

FIGS. 4A, 4B, and 4C are diagrams illustrating an exemplary user interface for digital image capture device for implementing a preferred embodiment of the present invention. FIG. 4A is a diagram illustrating the Image Size menu displayed on the display 14. Image capture device 100 also includes a four-way navigation controller 126 and one or more softkeys 128 for selecting the function displayed in the label above the corresponding softkey 128. In a preferred embodiment, the Image Size menu includes options for both pre-set image sizes as well as an option for setting a “Custom Size”.

Referring again to FIG. 3, in step 204, in response to the user selecting the Custom Size menu option, a screen is displayed allowing the user to set the image size of their choice.

FIG. 4B is a diagram illustrating the user interface of the Custom Size screen. In a preferred embodiment, the Custom Size screen displays two dimension entry fields 130, one for height and one for width. Each entry field may have spaces for four or more digits, where the digits in each space may be navigated to by pressing the left/right buttons on the navigation controller 126. The values in each space may be toggled by pressing the up/down buttons on the navigation controller 126 to displace the digits 0-9. Other input methods may also be used, such as entering values for the dimensions directly via a keypad that are included on devices such as camera phones and PDAs.

Alternatively, an aspect ratio field may be displayed on the Custom Size screen in lieu of, or in addition to, the pixel dimension fields 130 In this case, the pixel dimensions would be automatically calculated to use the maximum area of the sensor data consistent with the aspect ratio. In a third embodiment, all three fields can be shown, where the value in the aspect ratio field is calculated from pixel input from the user, and pixel values are calculated from the aspect ratio field. In this case, the user may enter either the pixel values or the aspect ratio value, and automatically view the calculation displayed in the other fields.

Referring again to FIG. 3, after the Custom Size screen is displayed, the user specifies the custom size by entering values in the displayed fields in step 206. In step 208, the processor 106 determines whether the user entered an invalid custom size. In embodiment, this is done by comparing the image size entered by the user with the maximum dimensions stored in the configuration file 122. If the custom size is invalid, then in step 210 the processor 106 alerts the user of the mistake and prompts the user to re-enter a valid image size. Alternatively, the Custom Size screen may automatically convert any pixel dimension entered that is larger than the sensor size into the maximum value available. An error message or warning may appear on the Custom Size screen in this case to let the user know why the entered value was automatically changed.

Upon successfully entering a custom image size and returning to capture mode, in step 212, the processor 106 saves the custom size in the custom size data structure 120 and instructs the image sensor 102 to capture a live view of the object using only an area of the image sensor that matches the dimension of the custom size. In step 214, a live view of the object captured by the image sensor 102 having the defined custom size is then displayed on the display 114, the viewfinder 116, or both. This live view image has the aspect ratio of the custom image size that the user entered.

In step 216, the user composes the image to their liking by focusing, zooming, etc. and initiates an image capture by the pressing a button, such as the shutter button, on the user input interface 110. In response, in step 218 the image sensor 102 captures digital image data of the object within view of the image sensor 102 using only the pixels falling within the custom size dimension. The remaining pixels of the image sensor 102 are unused. The image sensor 102 transfers image data to the digital camera front end signal processor 104 for processing in step 220. In step 222, the signal processor 104 transfers the digital image data to the processor 106, which performs various image processing functions on the image data, optionally displays the image as a preview on the LCD 114, and stores processed image data in an image file 124 in the memory 107. Both the preview and saved image have the custom dimensions/aspect ratio that were defined by the user.

As stated above, in an alternative embodiment, the user may enter a specific aspect ratio to set the custom size. In response, the processor may generate and provide a set of image resolution sizes that fit the aspect ratio for the user to choose from. One preferred implementation is to allow the user to select the target use, rather than enter an aspect ratio value. For example, viewing on your TV, or printing on a 4×6, or printing on an 8×10, or showing on your HDTV, or printing on 13×19 with a 1′ border. Each of these examples has a specific aspect ratio. As another example, a specific aspect ratio may be needed for a publication, e.g., 1″×1.5″ (printed)@300 dpi. The user could choose from a number of preset target uses that the user might actually use (many presets can be provided), or select an option to create his or her own, or to modify the description. Finally, once the target use is selected, the target use is used to instruct the processor 110 how to crop the viewfinder (in order for the user can see a proper framing of the final image), and also what resolution to generate.

In a second embodiment of the present invention, the image capture data is provided with the ability to upscale or downscale the image data directly from the raw sensor data, rather than having to interpolate the data after image capture. The image data may be upscaled in the case where the user has specified a custom pixel size larger than the image sensor, or the image data may be downscaled in the case where the user specifies a size smaller than the image sensor. In the case where the custom size is larger than the image sensor, the image capture device calculates the aspect ratio from the custom size, and captures the image by only digitizing pixel values for the largest area of the image sensor possible that maintains the calculated aspect ratio, rather than process the entire pixel array. The raw data will be available to the interpolation/scaling algorithm to make maximum use of the sensor data to create the output image. Because the raw sensor data is available, and the scaling function can be combined with the interpolation function, a better high resolution image will result than simply scaling an already interpolated and compressed image.

Downscaling provides the image capture device with the ability to output user-specified image sizes that are smaller than the sensor array. Although the simplest method of achieving this result is to crop the image sensor area according to the specified size, this has two major drawbacks: the image quality is only equivalent to the sensor output, and the viewfinder may be very small on an already tiny LCD screen or viewfinder. This embodiment of the present invention provides an improved approach to producing images smaller than the sensor size by taking the largest amount of sensor data available for the specified aspect ratio, and then interpolating and scaling the image data to the desired size. The combined interpolation and scaling function, including a carefully-designed sharpening algorithm will result in an image of higher quality because more than one sensor pixel data is used for each output pixel. The file created is of the specified size, but the quality is higher as the size is reduced. This of course will not reduce the processing load and battery drain, but nevertheless will reduce storage requirements and give superior results.

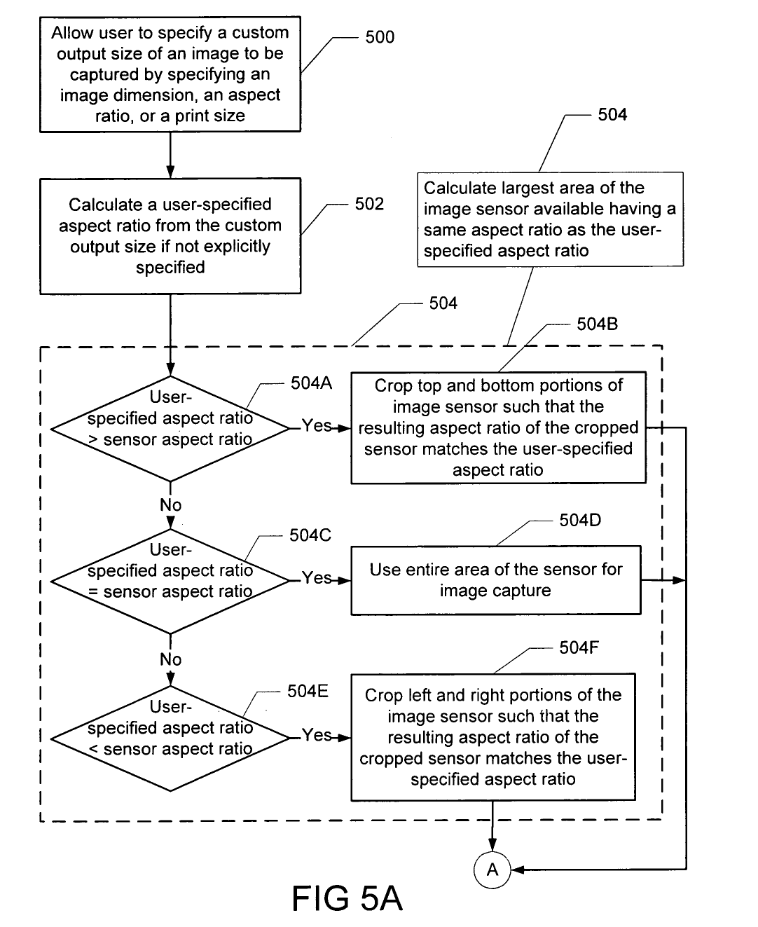

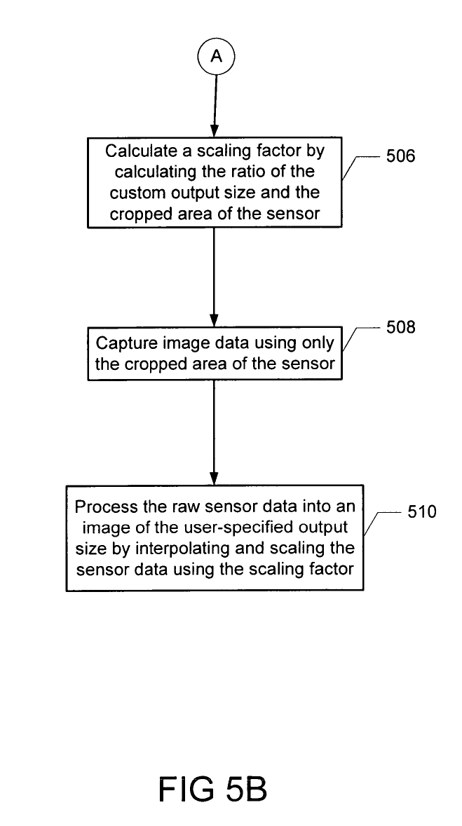

FIGS. 5A and 5B depict a diagram illustrating a more detailed process for establishing variable image sizes in accordance with the second embodiment in which scaling is performed. The process begins in step 500 by allowing a user to specify a custom output size of an image by specifying a value for an image dimension (e.g., in pixels), an aspect ratio of the image, or a print size of the image. Unless explicitly specified by the user in step 500, the image capture device calculates a user-specified aspect ratio from the user-specified custom output size in step 502.

In a preferred embodiment, the user specifies or selects a print size of the image in step 500. Either a print resolution is entered (pixels/unit distance) or an actual printer model is selected, from which the camera software can deduce the required print resolution. Alternatively, a default resolution may be used that will give good results on most printers. Typical values include 300 dpi, 288 dpi, or 360 dpi, depending on the printer. This would reduce the complexity for the user. The pixel dimensions of the output image can be determined by multiplying the desired print size by the resolution and the user-defined aspect ratio calculated, accordingly.

In step 504, the image capture device 100 calculates a largest area of the image sensor 102 available having a same aspect ratio as the user-specified aspect ratio. If, in step 504A, it is determined that the user-specified aspect ratio is greater than the aspect ratio of the sensor, then the top and bottom portions of the image sensor 102 are cropped in step 504B such that the resulting aspect ratio of the cropped sensor 102 matches the user-specified aspect ratio. If, in step 504C, it is determined that the two aspect ratios are equal, then the entire area of the sensor 102 is used for image capture in step 504D. If, in step 504E, it is determined that the user-specified aspect ratio is less than the aspect ratio of the sensor 102, then the left and right portions of the image sensor 102 are cropped in step 504F such that the resulting aspect ratio of the cropped sensor 102 matches the user-specified aspect ratio. Thus, in a preferred embodiment, when upscaling is required, the capture area on the sensor 102 is set to the specified aspect ratio by setting at least one dimension of the capture area equal to the sensor dimension.

In step 506, a scaling factor is calculated from the cropped area of the sensor 102 by calculating the ratio of the custom output size and the cropped area of the sensor 102. The camera displays only the selected area to be captured on the camera viewfinder if an electronic viewfinder is used, and the user can frame the image to be captured using this modified viewfinder display. In step 508, image data is captured using only the cropped area of the sensor 102. The processor 106 then processes the raw sensor data into an image of the user-specified output size in step 510 by interpolating and scaling the sensor data using the scaling factor.

In a preferred embodiment, the image capture device 102 may perform checks for extreme aspect ratios, and may set a maximum ratio, such as limiting the ratio to less than 5:1 might be a good idea (a panorama shot of 3:1 would be desirable as a capture selection). If the user specifies a smaller than sensor size image, an additional option of scaling or not scaling could be provided. Not scaling will reduce processing and battery drain, but will also reduce the viewfinder size (cropped viewfinder to match the capture data). Alternatively, the viewfinder image can be scaled up from the cropped sensor data to fill at least the horizontal or vertical dimension of the viewfinder LCD.

In addition to the “Custom Size” option described above, the Image Size menu depicted in FIGS. 4A, 4B, and 4C can also include options for specifying a “Custom Crop Size”, “Custom Print Size”, and “Custom Resize” of an image about to be captured using the image capture device. These additional output sizing options can be presented to the user via the display 14 either as options on the main Image Size menu, or as sub-options of the “Custom Size” sizing option.

The “Custom Crop Size” option allows the user to crop the image being captured. The crop size dimensions must be less than or equal to sensor size, and no scaling is performed with this option. Since only the portion of the sensor data corresponding to custom crop size is processed into the final image, this option reduces the image processing load on the capture device. If the selected crop size falls below a threshold, the live viewfinder image may be scaled up to fill the viewfinder, to make it easy for the user to frame the image to be captured.

The “Custom Print Size” option allows for resizing the image based on a user specified print size. With this sizing option, the user can either specify a particular printer connected (wired or wirelessly) to the image capture device, or specify the print size of the final image to be printed. The processor 106 can then determine an optimal scaling factor and crop size (the maximum size for determined aspect ratio) to yield the desired printed image.

The “Custom Resize” option allows final image size dimensions smaller than the sensor to be specified by the user. But, unlike the “Custom Crop Size” sizing option described above, with the “Custom Resize” option, the maximum area of the sensor for the computed aspect ratio is used to capture the image. The captured image data is then interpolated and scaled to create the final image. As described above, the combined interpolation and scaling of the captured image data will result in an image of higher quality than a cropped image, because more than one sensor pixel data is used to compute each output pixel.

A method and apparatus for allowing a user to establish variable image sizes in a digital image capture device has been disclosed. The present invention has been described in accordance with the embodiments shown, and one of ordinary skill in the art will readily recognize that there could be variations to the embodiments, and any variations would be within the spirit and scope of the present invention. For example, one extension to implement the present invention in an image capture device capable of network communication, and setting the variable image sizes remotely over the network, such as in the case of security cameras and, web cameras, etc. Accordingly, many modifications may be made by one of ordinary skill in the art without departing from the spirit and scope of the appended claims.

We claim:

1. A method for allowing a user to establish variable image sizes in a digital image capture device having an image sensor, comprising;
allowing the user to specify a custom output size for an image about to be captured using the image capture device by specifying a value for one of an image dimension, an aspect ratio of the image, and a print size of the image;
determining from the user-specified output size for the image a corresponding capture area of the image sensor;
capturing sensor data corresponding only to the capture area of the image sensor; and
processing the captured sensor data into the image of the user-specified output size.

2. The method of claim 1 further including: after capturing the image, outputting the image data as an image file.

3. The method of claim 2 further including: displaying on the user interface, a live view image of a scene about to be captured by the image sensor using only an area of the image sensor that matches the dimension/aspect ratio of the custom size defined by the user.

4. The method of claim 3 further including: if the live view image falls beneath a predetermined threshold size, then upscaling the live view image to provide the user with a larger view.

5. The method of claim 4 further including: providing a charge coupled device (CCD) as the image sensor, and shifting all of the unnecessary pixel rows outside of the capture area down and discarding those pixels prior to processing the pixels comprising the image.

6. The method of claim 4 further including: providing a complementary metal oxide semiconductor (CMOS) as the image sensor, and acquiring only pixels defined by the capture area.

7. The method of claim 1 further including: allowing the user to enter custom height and width (H×W) pixel-dimensions, thereby inherently setting the aspect ratio.

8. The method of claim 7 further including: allowing the user to enter pixel width independent of setting the pixel height, thereby allowing a range between 1 and the image sensor's physical limits for either dimension.

9. The method of claim 1 further including: allowing the user to enter a specific aspect ratio to set the custom size.

10. The method of claim 9 further including: in response to the user entering a specific aspect ratio, generating and displaying a set of image resolution sizes that fit the specific aspect ratio for user selection.

11. The method of claim 1 further including: allowing the user to select a target use to set the custom size.

12. The method of claim 1 further including: determining, by the image capture device, whether the custom size entered by the user is valid.

13. The method of claim 12 further including: alerting the user of an invalid entry.

14. The method of claim 13 further including: determining whether the custom size entered by the user is valid by comparing a custom size with the maximum pixel dimensions of the image sensor.

15. The method of claim 1 further including: performing at least one of upscaling the image data when the user has specified a custom size larger than the image sensor, and down-scaling the image data when the user specifies a custom size smaller than the image sensor.

16. The method of claim 15 further including: in the case where the custom size is larger than the image sensor, calculating the aspect ratio from the custom size, and capturing the image by only digitizing pixel values for the largest area of the image sensor possible that maintains the calculated aspect ratio.

17. The method of claim 1 wherein when the user-specified output size for the image requires less than the full capture area of the image sensor, the method includes;
capturing sensor data corresponding to a maximum capture area of the image sensor; and
interpolating and downscaling the captured sensor data to create the user-specified output size for the image.

18. A digital image capture device, comprising:
a image sensor for capturing digital image data;
at least one memory;
a user interface including at least one display; and
a processor coupled to the image sensor, the memory and the user interface, the processor programmed to perform functions of:
allowing a user to specify a custom output size for an image about to be captured using the image capture device by specifying a value for one of an image dimension, an aspect ratio of the image, and a print size of the image;
determining from the user-specified output size for the image a corresponding capture area of the image sensor;
capturing sensor data corresponding only to the capture area of the image sensor; and
processing the captured sensor data into the image of the user-specified output size.

19. The system of claim 18 wherein the processor stores the capture data as an image file.

20. The system of claim 19 wherein the processor displays on the user interface a live view image of a scene about to be captured by the image sensor using only an area of the image sensor that matches the dimension/aspect ratio of the custom size defined by the user.

21. The system of claim 20 wherein if the live view image falls beneath a predetermined threshold size, then upscaling the live view image to provide the user with a larger view.

22. The system of claim 18 wherein the image sensor comprises a charge coupled device (CCD), and wherein all of the unnecessary pixel rows outside of the capture area down are shifted down such that those pixels are discarded prior to processing the pixels comprising the image.

23. The system of claim 18 wherein the image sensor comprises a complementary metal oxide semiconductor (CMOS), and only pixels defined by the capture area are required by the image sensor.

24. The system of claim 18 wherein the processor allows the user to enter custom height and width (H×W) pixel-dimensions, thereby inherently setting the aspect ratio.

25. The system of claim 24 wherein a processor allows the user to enter pixel width independent of setting the pixel height, thereby allowing a range between 1 and the image sensor's physical limits for either dimension.

26. The system of claim 18 further including: allowing the user to enter a specific aspect ratio to set the custom size.

27. The system of claim 26 further including: in response to the user entering a specific aspect ratio, generating and displaying a set of image resolution sizes that fit the specific aspect ratio for user selection.

28. The system of claim 18 further including: allowing the user to select a target use to set the custom size.

29. The system of claim 18 wherein the memory includes a configuration file stores a maximum dimension of the image sensor, and wherein the processor determines whether the custom size entered by the user is valid by comparing a custom size with the maximum dimensions of the image sensor.

30. The system of claim 18 further including: performing at least one of upscaling the image data when the user has specified a custom size larger than the image sensor, and down-scaling the image data when the user specifies a custom size smaller than the image sensor.

31. The system of claim 18 further including: in the case where the custom size is larger than the image sensor, calculating the aspect ratio from the custom size, and capture the image by only digitizing pixel values for the largest area of the image sensor possible that maintains the calculated aspect ratio.

32. A method for allowing a user to establish variable image sizes in an image capture device, comprising:
prior to image capture, allowing the user to enter a custom output size for the image by specifying one of an image dimension, an aspect ratio of the image, and a print size of the image;
in response to the user initiating an image capture, instructing the image sensor to only capture the pixels in the image sensor falling within the custom output size set by the user; and
saving pixel data captured by the image sensor in an image file that has the pixel height and width specified by the custom output size.

33. A method for allowing a user to establish variable image sizes in a digital image capture device having an image sensor, comprising:
allowing a user of the image capture device to specify a custom output size for an image about to be captured using the image capture device by specifying a value for one of an image dimension, an aspect ratio of the image, and a print size of the image;
calculating a user-specified aspect ratio from the custom output size if not explicitly specified;
calculating a largest area of the image sensor available having a same aspect ratio as the user-specified aspect ratio by:
in response to the user-specified aspect ratio being greater than an aspect ratio of the image sensor, cropping top and bottom portions of the image sensor such that an aspect ratio of the cropped image sensor matches the user-specified aspect ratio;
in response to the user-specified aspect ratio being equal to the aspect ratio of the image sensor, using the entire area of the sensor for image capture; and
in response to the user-specified aspect ratio being less than an aspect ratio of the image sensor, cropping left and right side portions of the image sensor such that the aspect ratio of the cropped image sensor matches the user-specified aspect ratio;
calculating a scaling factor from the cropped area of the image sensor by calculating a ratio of the custom output size and the cropped area of the image sensor;
capturing sensor data corresponding only to the cropped area of the image sensor; and
processing the captured sensor data into the image of the user-specified output size by interpolating and scaling the sensor data using the scaling factor.

34. The method of claim 33 further including: calculating the aspect ratio by retrieving the aspect ratio from a table based on the custom output size.

35. The method of claim 34 further including: in response to the user-specified aspect ratio being equal to the aspect ratio of the image sensor, using an entire area of the sensor for image capture.

36. The method of claim 35 further including: when upscaling is required, setting a capture area on the sensor to the user-specified aspect ratio by setting at least one dimension of the capture area equal to a sensor dimension.

37. A computer readable medium containing program instructions for a method and apparatus for allowing a user to establish variable image sizes in a digital image capture device having an image sensor, the program instructions for:
allowing a user of the image capture device to specify a custom output size for an image about to be captured using the image capture device by specifying a value for one of an image dimension, an aspect ratio of the image, and a print size of the image;
determining from the user-specified output size for the image a corresponding area of the image sensor that should be captured;
capturing sensor data corresponding only to the determined sensor area; and
processing the captured sensor data into the image of the user-specified output size.
